(19) United States
(12) Patent Application Publication
(10) Pub. No.: US 2024/0428479 A1
(43) Pub. Date: Dec. 26, 2024

(54) Monitoring Device

(71) Applicant: Leuze electronic GmbH + Co. KG, Owen/Teck (DE)

(72) Inventors: Bernhard Feller, Friedberg (DE); Frank Schreiber, Baienfurt (DE); Hermann Haberer, München (DE); Joachim Koperski, Ottobrunn (DE); Viktor Wursthorn, Erkenbrechtsweiler (DE); Hasko Eckhardt, Tübingen (DE)

(21) Appl. No.: 18/747,481

(22) Filed: Jun. 19, 2024

(30) Foreign Application Priority Data
Jun. 22, 2023 (EP) 23181052.4

(51) Int. Cl. G06T 11/20; F16P 3/14; G06T 5/80

(52) U.S. Cl. CPC G06T 11/203; F16P 3/14; G06T 5/80; G06T 2200/24; G06T 2207/30232

(57) ABSTRACT

A monitoring device (1) with a safety sensor (4) designed for performing a protection field monitoring. A configuration unit (8) is provided for configuring protection fields (7) for the protection field monitoring performed with the safety sensor (4). The configuration unit (8) has a graphical drawing interface (22) in which a graphical information of a hazard region (2) within which a protection field (7) is to be configured is superimposed. Elements of the graphical information are used for configuring the protection field (7).

### CROSS REFERENCE TO RELATED APPLICATIONS

This application claims the priority of EP 23181052.4 filed on 2023 Jun. 22; this application is incorporated by reference herein in its entirety.

### BACKGROUND

The invention relates to a monitoring apparatus.

Such monitoring apparatuses are used in particular for hazard region monitoring at hazardous equipment. A hazard region at such an equipment is monitored with an optical sensor, which is generally designed as a scanning sensor such that a monitoring region, in particular the hazard region, is scanned periodically with the light beams of a transmitting/receiving unit of this optical sensor. The optical sensor can be designed in particular as an area distance sensor, i.e. a scanning distance sensor, with which positions of objects in the monitoring region can be determined.

In known monitoring apparatuses, scanning optical sensors are used such that with them, an object monitoring takes place not in the entire monitoring region, i.e. hazard region, but rather only within a preset protection field. The protection field is stored as a parameter in the optical sensor, wherein its dimension is optimally adjusted to the hazard region to be monitored.

The measurement data generated with the optical sensor is evaluated in the optical sensor. An evaluation unit is integrated in the optical sensor for this purpose, which evaluates the received signals pending at the output of a receiver of the transmitting/receiving unit. In this context, a binary object determination signal is generated, the switching states of which indicate whether an object is located within the protection field.

This object determination signal is output to a controller that controls the equipment. When an object determination signal that signals that no object is present in the protection field is output, the operation of the equipment is released. If the optical sensor generates an object determination signal with the switching state corresponding to an object detection in the protection field, the equipment is brought to a standstill by means of the controller through this object determination signal to prevent hazardous conditions.

Depending on the respective application or also depending on the operating state of the equipment, it can be necessary to adjust the hazard region monitoring. This is achieved in that different protection fields are stored in the optical sensor, wherein the most suitable protection field is activated depending on requirements.

Using configuration units connected to the safety sensor is known for configuring protection fields. Protection fields are configured in a configuration operation that is separated from a working operation in which the safety sensor performs the protection field monitoring.

In principle, measurement data of the safety sensor can be used for calculating protection fields, especially their contours. If the safety sensor is offline during the configuration operation, however, these measurement values are not available. Moreover, the measurement values of the safety sensor alone are not sufficient for configuring protection fields. Hazard points within the hazard region must be explicitly preset by a user through user inputs to the configuration unit. Moreover, environmental conditions present in the hazard region must be considered, such as protection fences, spatial dividers or machinery parts.

All of these geometrical boundary conditions must be considered by a user through manual inputs in the configuration unit while configuring protection fields. These processes not only waste time, they are also prone to error.

### SUMMARY

The invention relates to a monitoring device (1) with a safety sensor (4) designed for performing a protection field monitoring. A configuration unit (8) is provided for configuring protection fields (7) for the protection field monitoring performed with the safety sensor (4). The configuration unit (8) has a graphical drawing interface (22) in which a graphical information of a hazard region (2) within which a protection field (7) is to be configured is superimposed. Elements of the graphical information are used for configuring the protection field (7).

### DETAILED DESCRIPTION

The invention seeks to solve the problem of enabling a user-friendly and, at the same time, secure configuration of protection fields in a monitoring apparatus of the type mentioned at the outset.

The features of claim 1 are provided to solve this problem. Advantageous embodiments of the invention and appropriate further developments are described in the dependent claims.

The invention relates to a monitoring device with a safety sensor designed for performing protection field monitoring. A configuration unit is provided for configuring protection fields for the protection field monitoring performed with the safety sensor. The configuration unit has a graphical drawing interface in which a graphical information of a hazard region within which a protection field is to be configured is superimposed. Elements of the graphical information are used for configuring the protection field.

The invention further relates to a method for operating a monitoring device.

In a working operation of the safety sensor, it performs a protection field monitoring and thereby secures a hazard region at an equipment, wherein the term equipment also comprises in general machines, vehicles, robots, and similar.

In principle, the safety sensor can be designed as a radar sensor or ultrasound sensor. Advantageously, the safety sensor is an optical sensor. In this context, the optical sensor can be an area distance sensor with which a planar monitoring region is monitored. Accordingly, the protection fields also form planar, two-dimensional regions for this area distance sensor. Alternatively, the optical sensor can be a camera sensor with which a three-dimensional region can be monitored. With it, in principle, three-dimensional protection fields can also be monitored. Advantageously, the protection fields are two-dimensional regions in this case as well.

The safety sensor generally has an evaluation unit, in which the sensor signals of sensor components of the safety sensor are evaluated. In this context, a protection field monitoring generally occurs such that it is checked in the evaluation unit whether an object is present in an activated protection field of the safety sensor or not. Depending thereon, the evaluation unit generates as an object determination signal a binary switching signal, the switching states of which indicate whether an object is located in the protection field or not. An object in the protection field is classified as a hazardous condition, such that the corresponding signal triggers a safety function that transitions the monitored equipment into a safe condition, in particular, brings it to a standstill.

To meet the requirements for a use of the safety sensor in technical safety applications, the evaluation unit has a failsafe design. For example, this is realized in that the evaluation unit consists of two mutually monitoring computer units.

In the simplest case, only one protection field can be stored in the safety sensor, in particular in its evaluation unit. Then the protection field monitoring always occurs with the same protection field during working operation. Alternatively, multiple protection fields can be stored in the safety sensor. Then different protection fields for protection field monitoring can be activated depending on application conditions.

Advantageously, the protection field(s) form suitable partial regions of a hazard region at an equipment that is being monitored with the safety sensor.

In any case, it is necessary to adjust the protection field(s) to the respective circumstances of the hazard region. For this purpose, the protection fields are configured in a configuration operation, which preferably is separated from the working operation.

For this purpose, a configuration unit is connected to the safety sensor. Advantageously, the connection is made by means of a bidirectional, failsafe data connection, such as a secure bus system, e.g. PROFIsafe, CIPsafety or FSoE. The data is transmitted via the bus system by means of a secure bus protocol.

The configuration unit has a computer, such as a PC, for example. Furthermore, the configuration unit has a graphical drawing interface in which a user can configure the respective protection field in a graphic-supported manner.

According to the invention, a graphical information of the hazard region to be monitored is integrated, i.e. superimposed, in the graphical drawing interface. In general, a complete hazard region or only a relevant part of the hazard region can be superimposed.

A user thus receives a graphical specification of the place and shape of the hazard region within which the respective protection field is to be configured.

In this context, it is essential that the hazard region be depicted realistically, preferably to scale, by the graphical information. Within this depiction, the user can easily and simply configure the protection field through suitable inputs taking into consideration the actual spatial circumstances of the hazard region. An exact adjustment of the protection field to the hazard region, especially also to objects present there, such as protection fences, spatial dividers, machinery parts and similar is thereby enabled in a simple way.

Through the depicted graphical information, the user receives a graphical information about the hazard region that enables the user to quickly and intuitively define a protection field. In this context, parts of the depicted graphical information can be used by the user for defining the protection field, which represents a significant simplification.

According to a first embodiment, the graphical information superimposed in the graphical drawing interface can be a CAD depiction.

Advantageously, the CAD depiction is a CAD drawing, i.e. a two-dimensional depiction of the hazard region. This depiction is suitable for configuring planar, two-dimensional protection fields. In principle, when the graphical drawing interface is 3D-capable, a 3D-CAD depiction can also be superimposed in the graphical drawing interface. In this case, the graphical information can be used not only for configuring two-dimensional protection fields, but rather also for configuring three-dimensional protection fields.

According to a second variant, the graphical information is a photo of the hazard region.

This photo is a two-dimensional depiction, such that this is suitable for configuring two-dimensional protection fields.

According to an advantageous embodiment, the graphical information is to scale.

This can be the case especially for graphical information in the form of CAD depictions. For graphical information in the form of photos, a to-scale reproduction is only given from suitable perspectives from which the photo was taken, for example, when the hazard region is photographed exactly from above in a top-down view.

In a to-scale graphical information, a user can graphically specify and thus configure the protection field using the graphical information, especially geometric features present there. Since the graphical information of the hazard region is to-scale, the user can thus simply define the protection field adjusted to the real circumstances of the hazard region.

For graphical information that is not to-scale, the depiction of the hazard region is distorted. A distorted graphical information contains markings, advantageously scales, on the basis on which a distortion correction of the graphical information takes place.

Based on the markings and the associated scales, the graphical information can be distortion-corrected, such that a to-scale depiction of the hazard region is again obtained. Based on this to-scale depiction of the hazard region, the user can again configure the protection field geometrically, also to scale.

Especially advantageously, the graphical information is to-scale labeled with markings of the spatial axes, on the basis of which the distorted graphical information is converted into a graphical depiction in a plane.

This enables a simple and precise distortion correction of the distorted graphical information.

According to an especially advantageous embodiment of the invention, elements of the graphical information are marked on the graphical drawing interface, wherein marked elements are adopted as protection field-contour elements, or protection field-contour elements are calculated from marked elements.

In another embodiment, no distortion correction of the superimposed graphical depiction occurs, rather the distortion correction is considered in the calculation of the protection field contours. For showing the protection field contour in the graphical depiction, the calculated/determined protection field contours are distorted such that these correspond to the distortion of the superimposed graphical information and can thereby be superimposed such that the user is given a suitable idea of the protection field contour.

This means that image information about the hazard region contained in the graphical information can be directly adopted as protection field elements, i.e. protection field-contour elements, or can be calculated, especially through suitable calculation instructions stored in the configuration unit.

This makes configuring a protection field considerably easier, since the user does not have to draw the protection field contour freehand, which results in imprecision, on the one hand, and is moreover error-prone. Instead, the graphical information provides exact, to-scale image information that can be directly used for specifying a protection field.

For example, line elements can be marked in a graphical information in the form of a CAD depiction and can serve for forming protection field contour suggestions.

Furthermore, contrast edges can be marked in a graphical information in the form of a photo and can serve for forming protection field contour suggestions.

In the simplest case, straight lines are formed from the marked line elements of a CAD depiction or from marked contrast edges in a photo, which straight lines can be used as components of a protection field contour.

Furthermore, it is possible for polygonal chains and/or support points to be calculated from marked elements, the polygonal chains and/or support points serving for calculation of protection field contour elements or constituting protection field contour elements.

The procedure for configuring a protection field is such that based on protection field contour elements, a protection field contour suggestion is calculated, which is displayed on the graphical region interface.

In the event that an online connection exists between the safety sensor and the configuration unit during the configuration operation, measurement data of the safety sensor can additionally be used for calculating a protection field contour suggestion.

A completed protection field contour is then displayed on the graphical drawing interface. A user can then still make changes or corrections to the protection field contour.

Once the protection field contour has been finalized, the user confirms this by a corresponding input and the protection field contour is loaded into the safety sensor by the configuration unit.

The protection field is generated in the safety sensor in a failsafe manner through the verified setting of the protection field and the failsafe transmission of the protection field from the configuration unit to the safety sensor.

### BRIEF DESCRIPTION OF THE DRAWINGS

The invention is explained below on the basis of the drawings. The drawings show:

FIG. 1: an exemplary embodiment of the monitoring device according to the invention.

FIG. 2: Safety sensor of the monitoring device according to FIG. 1 with a configuration unit.

FIG. 3: First example of a safety sensor in the form of an area distance sensor.

FIG. 4: Second example of a safety sensor in the form of an area distance sensor.

FIG. 5: Example of a safety sensor in the form of a camera sensor.

FIG. 6: First exemplary embodiment of the graphical drawing interface with a superimposed CAD depiction.

FIG. 7: Second exemplary embodiment of the graphical drawing interface with a superimposed photo.

FIG. 8: Third exemplary embodiment of the graphical drawing interface with a superimposed photo.

### DETAILED DESCRIPTION OF THE PREFERRED EMBODIMENTS

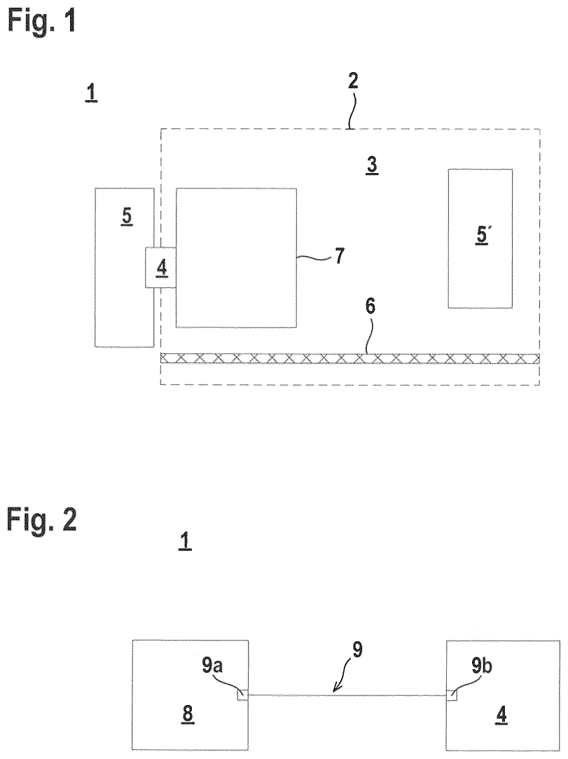

FIG. 1 shows a schematic depiction of an exemplary embodiment of the monitoring device 1 according to the invention. The monitoring device 1 serves for monitoring a hazard region 2 of an equipment 3. A safety sensor 4 is used for this monitoring as a component of the monitoring device 1. The safety sensor 4 is mounted on a machine 5, which is a component of the equipment 3. An additional machine 5′ and a protection fence 6 are located in the hazard region. Of course, other designs of an equipment 3 are possible.

Protection field monitoring is carried out with the safety sensor 4. For this purpose, a protection field 7 covering a part of the hazard region 2 is activated in the safety sensor 4. If an object O is detected in the protection field 7 by the safety sensor 4, this is evaluated as a hazard condition and a safety function is triggered, for example, the equipment 3 or parts thereof are brought to a standstill. In general, multiple protection fields 7 can be stored in the safety sensor 4, such that different protection fields 7 can be activated depending on actual application conditions.

A configuration unit 8 is provided (FIG. 2) for configuring protection fields 7 for the safety sensor 4. The configuration unit 8 is connected to the safety sensor 4 via a bidirectional data connection 9, wherein the safety sensor 4 and the configuration unit 8 have interface modules 9a, 9b suitable for this. Advantageously, the data transmission via the data connection 9 is failsafe. For example, the data connection 9 is constituted by a secure bus system.

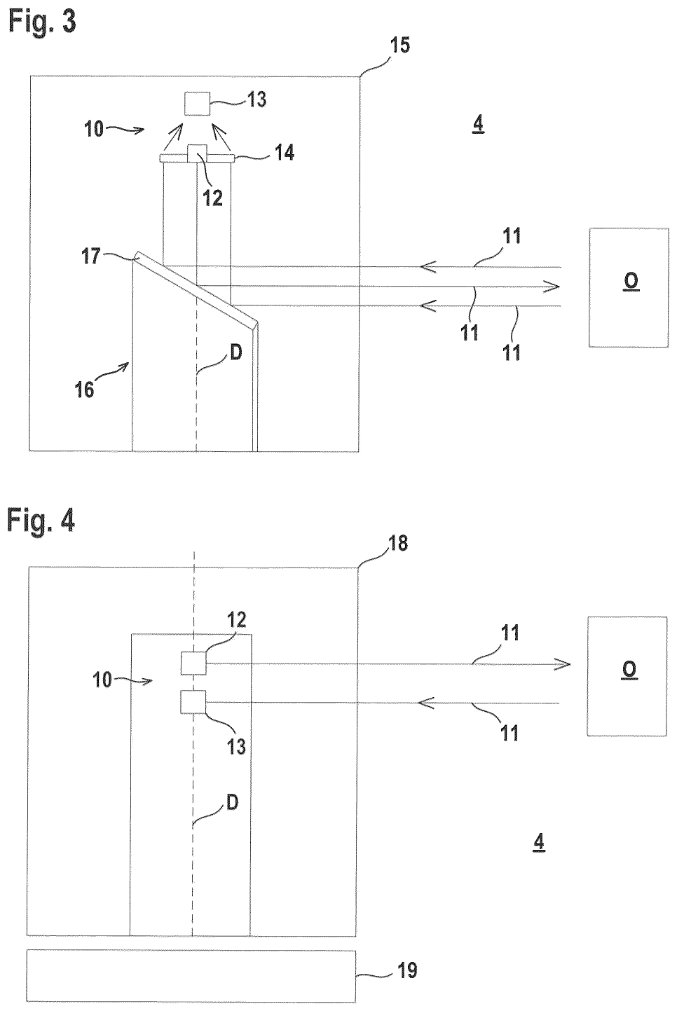

FIG. 3 shows a first exemplary embodiment of the safety sensor 4 in the form of an optical sensor, which in the present case is designed in the form of an area distance sensor.

The optical sensor has at least one transmitting/receiving unit 10 with a light-beam 11 emitting transmitter 12 and a light-beam 11 receiving receiver 13. The transmitter 12 is constituted by a laser diode, for example, the receiver 13 is constituted by a photo diode, for example. The receiver 13 has an associated receiving lens 14. The transmitting/receiving unit 10 is integrated stationarily into a housing 15.

Also provided in the housing 15 is a deflection unit 16, which has a motor-driven deflection mirror 17 rotatable about a rotary axis D. The light-beams 11 emitted by the transmitter 12 and the light-beams 11 reflected back by an object O to be detected are guided via the deflection mirror 17. Through the rotary movement of the deflection mirror 17, the light-beams 11 are periodically guided in the monitoring region. The current rotary position of the deflection mirror 17 is detected by means of an angular encoder and thus the current beam direction of the light-beams 11 is detected.

In the present case, the transmitting/receiving unit 10 constitutes a distance sensor working according to a pulse-travel time method. Alternatively, distance measurements can be carried out according to a phase measurement method.

FIG. 4 shows a second embodiment of the optical sensor. In this case, a transmitting/receiving unit 10 with a light-beam 11 emitting transmitter 12 and a light-beam 11 receiving receiver 13 is arranged in a rotating measurement head 18. In this case, the measurement head 18, rotatable about a rotary axis D and mounted on a stationary socket 19, effects the periodical deflection of the light-beams 11 in the monitoring region. Otherwise, the optical sensor according to FIG. 4 corresponds to the embodiment according to FIG. 3.

A two-dimensional detection region is detected with the safety sensor 4 in the form of the area distance sensor. Accordingly, protection field monitoring is carried out in two-dimensional protection fields 7 with the safety sensor 4.

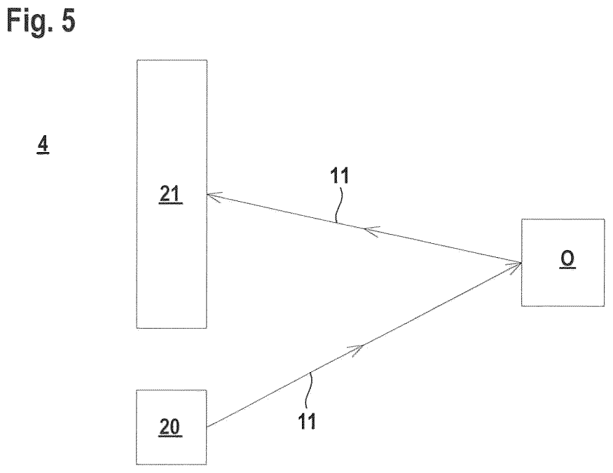

FIG. 5 shows an exemplary embodiment of the safety sensor 4 in the form of a camera sensor. This camera sensor has a light-beam 11 emitting transmitting unit 20 and a receiving unit 21 in the form of an image sensor with a matrix-shaped arrangement of receiving elements. The image sensor can be constituted by a CMOS or CCD array. In this case as well, a distance measurement is made with the light-beams 11, especially according to a pulse-travel time method.

Object detection in a three-dimensional detection region takes place with the camera sensor. Accordingly, the protection fields 7 can constitute two- or three-dimensional regions.

The safety sensor 4 has an evaluation unit in which the received signals of the receiver 13 or, respectively, of the receiving unit 21, are evaluated. The evaluation unit has a failsafe structure. For example, the evaluation unit consists of two mutually cyclically monitoring computer units.

Protection field monitoring is carried out with the safety sensor 4. In this context, it is established with the safety sensor 4 whether an object O, especially a safety-critical object O, is present in the protection field 7 or not. Depending thereon, the safety sensor 4 generates as an object determination signal a binary switching signal, the switching states of which indicate whether an object O is located in the protection field 7 or not. If an object O is detected in the protection field 7 with the safety sensor 4, this corresponds to a hazardous condition. The switching signal generated thereby, which is output via an output of the safety sensor 4, is used to trigger a safety function of the equipment which consists, for example, in bringing the equipment 3 to a standstill.

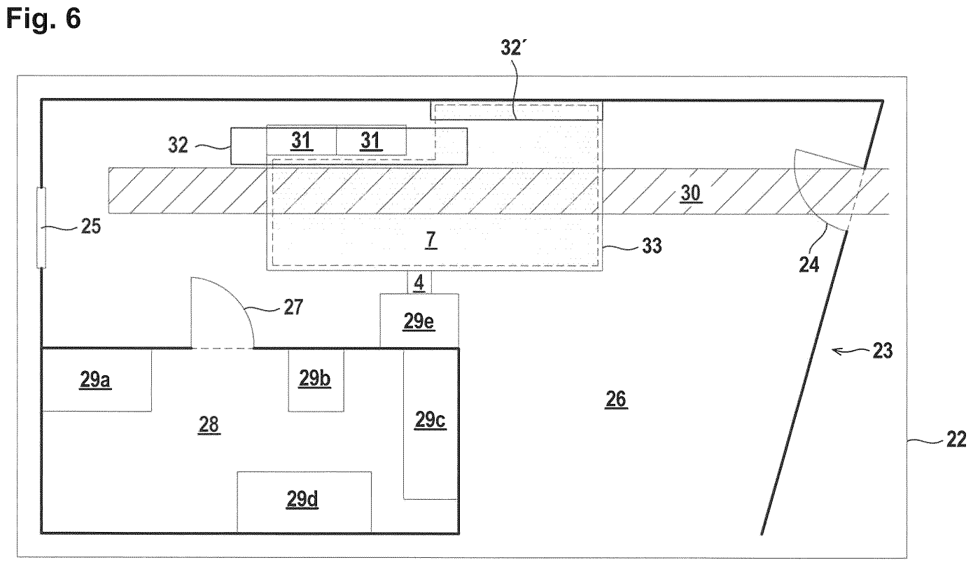

The examples of FIGS. 6 to 8 illustrate the functioning according to the invention of the monitoring device 1 and the method according to the invention for configuring protection fields 7.

The configuration unit 8 has a graphical drawing interface 22 on which, according to the invention, graphical information of the hazard region 2 can be depicted, on the basis of which a user can configure a protection field 7 by inputs to the configuration unit 8.

In the example according to FIG. 6, the graphical information is constituted by a CAD drawing, which is depicted to-scale on the graphical drawing interface 22.

On the CAD drawing, a closed hazard region 2 is provided in the form of a hall 23, which has a door 24 and an emergency exit 25. In the hall 23 there is a laboratory 26 and a work room 28 closable with an additional door 27, the work room 28 having processing machines 29a-29d. In the hall 23, a conveying device 30 runs along cabinets 31. The safety sensor 4 is located on an additional processing machine 29e.

In the CAD drawing, the user can label existing lines by region markings 32, 32′. Furthermore, the user can mark auxiliary lines 33 for specifying a protection field contour.

Protection field contour elements can be derived from the lines of the CAD drawing labeled with the region markings 32, 32′. This can be done directly by adopting the lines from the CAD drawing. Alternatively, from the lines, polygonal chains or support points can be calculated, from which in turn protection field contour elements are calculated. The same applies correspondingly to the auxiliary lines 33.

A protection field contour suggestion is calculated from the protection field contour elements, as the case may be in connection with measurement values of the safety sensor 4, if this is connected online to the configuration unit 8 during the configuration operation. This protection field contour suggestion with the corresponding protection field 7 is displayed to the user on the graphical drawing interface.

As shown in FIG. 6, the protection field 7 thus calculated is adjusted to the circumstances of the hazard region 2, wherein it is ensured especially that no stationary objects are present in the protection field 7, such that these do not trigger any object report in the safety sensor 4 during the protection field monitoring.

The user can still change or correct the protection field contour suggestion. Once the protection field 7 has been finalized, it is loaded into the safety sensor 4 via the data connection 9 and can be used there by safety sensors 4 for protection field monitoring.

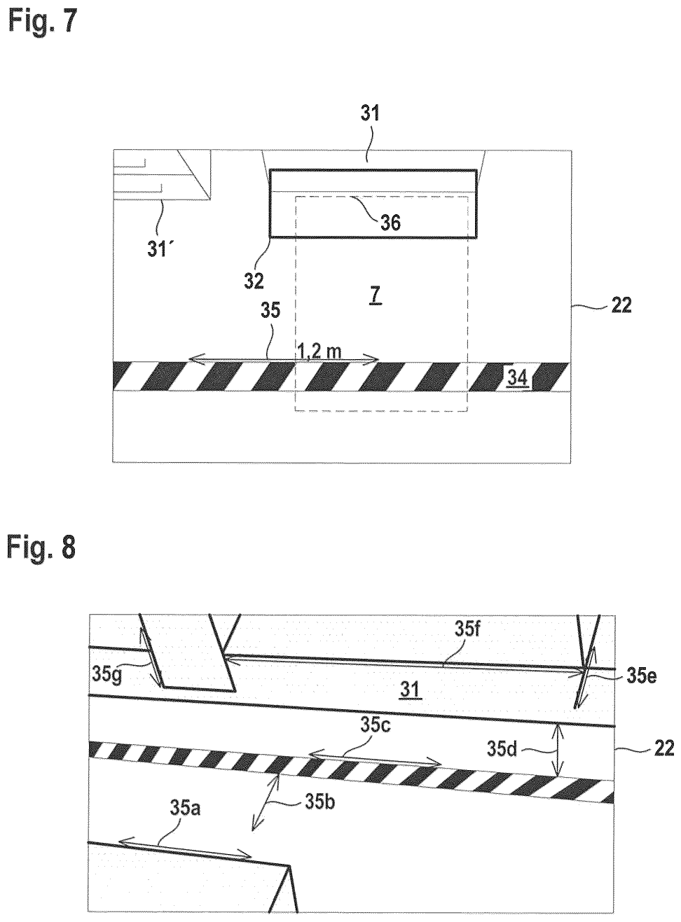

FIG. 7 shows an example in which a photo of the hazard region 2 is superimposed in the graphical drawing interface 22 as graphical information.

In the present case, the photo shows a to-scale depiction of the hazard region 2.

As FIG. 7 shows, cabinets 31, 31′ are again present in the hazard region 2, which cabinets 31, 31′ are to be omitted in a protection field 7 to be configured.

A marking strip 34 is located on the floor of the hazard region 2. In the photo, a scale specification 35 in the form of a double arrow with the distance specification 1.2 m, which is to scale, is contained on this marking strip 34. Alternatively, this measurement can also be measured by the operator and be input into the configuration system as a scale specification.

Based on the scale specification, the dimensions of the hazard region 2 and objects present there, which also includes the safety sensor 4, are available to-scale.

With this, the user can create a protection field contour suggestion directly based on the photo (just as based on the CAD drawing according to FIG. 6). The corresponding method proceeds in parallel with the exemplary embodiment according to FIG. 6. In particular, region markings 32 can be used again, wherein in the present case they mark contrast lines 36 from which protection field contour suggestions are derived.

The remainder of the method for configuring the protection field 7 takes place analogously to the embodiment according to FIG. 6.

FIG. 8 shows an example of a photo with angle and scale distortion, which is superimposed in the graphical drawing interface 22 as graphical information.

In this photo as well, a hazard region 2 is present with cabinets 31 and a marking strip 34 on the floor.

To distortion-correct the photo, e.g. scale specifications 35a-35g are contained in the photo.

A configuration of a protection field 7 can then be performed based on the distortion-corrected photo, analogous to the embodiment according to FIG. 7.

### List of Reference Numerals

(1) monitoring device

(2) hazard region

(3) equipment

(4) safety sensor

(5) machine

(5′) machine

(6) protection fence

(7) protection field

(8) configuration unit

(9) data connection

(9a, b) interface module

(10) transmitting/receiving unit

(11) light beam

(12) transmitter

(13) receiver

(14) receiving optics

(15) housing

(16) deflection unit

(17) deflection mirror

(18) measurement head

(19) Support

(20) transmitting unit

(21) receiving unit

(22) graphical drawing interface

(23) hall

(24) door

(25) emergency exit

(26) laboratory

(27) door

(28) work room

(29a-e) processing machine

(30) conveying device

(31) cabinet

(31′) cabinet

(32) region marking

(32′) region marking

(33) auxiliary line

(34) marking strip

(35) scale specification

(35a-g) scale specifications

(36) contrast line

(D) rotary axis

(O) object

1. A monitoring device (1) with a safety sensor (4), which is designed for performing a protection field monitoring and can be connected to a configuration unit (8) designed for configuring protection fields (7) for the protection field monitoring performed with the safety sensor (4), characterized in that the configuration unit (8) has a graphical drawing interface (22), in that a graphical information of a hazard region (2) within which a protection field (7) is to be configured is superimposed in the graphical drawing interface (22), and in that elements of the graphical information are used for configuring the protection field (7).

2. The monitoring device (1) according to claim 1, characterized in that the graphical information is a CAD depiction or a photo.

3. The monitoring device (1) according to claim 1, characterized in that the graphical information is to-scale.

4. The monitoring device (1) according to claim 1, characterized in that for a distorted graphical information, markings with a scale are contained or can be input therein, on the basis of which a distortion correction of the graphical information takes place in the configuration unit (8).

5. The monitoring device (1) according to claim 4, characterized in that spatial axes are labeled with markings on the basis of which the distorted graphical information is converted into a graphical depiction in a plane.

6. The monitoring device (1) according to claim 1, characterized in that elements of the graphical information are marked on the graphical drawing interface, wherein marked elements are adopted as protection field-contour elements, or in that protection field-contour elements are calculated from marked elements.

7. The monitoring device (1) according to claim 6, characterized in that line elements are marked in a graphical information in the form of a CAD depiction and serve for forming protection field contour suggestions.

8. The monitoring device (1) according to claim 6, characterized in that contrast edges are marked in a graphical information in the form of a photo and serve for forming protection field contour suggestions.

9. The monitoring device (1) according to claim 6, characterized in that polygonal chains and/or support points are calculated from marked elements, the polygonal chains and/or support points serving for calculation of protection field contour elements or constituting protection field contour elements.

10. The monitoring device (1) according to claim 7, characterized in that based on protection field contour elements, a protection field contour suggestion is calculated, which is displayed on the graphical drawing interface.

11. The monitoring device (1) according to claim 10, characterized in that measurement data of the safety sensor (4) is used for calculating a protection field suggestion.

12. The monitoring device (1) according to claim 10, characterized in that a protection field contour suggestion displayed on the graphical drawing interface is modifiable.

13. The monitoring device (1) according claim 12, characterized in that a protection field contour suggestion displayed on the graphical drawing interface can be confirmed by inputs to the configuration unit (8), and in that a confirmed protection field contour suggestion is adopted as a protection field (7) in the safety sensor (4).

14. The monitoring device (1) according to claim 1, characterized in that the safety sensor (4) is constituted by an area distance sensor or a camera sensor.

15. The monitoring device (1) according to claim 1, characterized in that the configuration unit (8) and the safety sensor (4) are connected by a bidirectional, failsafe data connection (9).
